(19) United States
(12) Patent Application Publication
(10) Pub. No.: US 2023/0313605 A1
(43) Pub. Date: Oct. 5, 2023

(54) WINDOW SHADE AND ACTUATING SYSTEM THEREOF

(71) Applicant: Teh Yor Co., Ltd., New Taipei City (TW)

(72) Inventor: Chung-Chen HUANG, New Taipei City (TW)

(73) Assignee: Teh Yor Co., Ltd., New Taipei City (TW)

(21) Appl. No.: 18/123,228

(22) Filed: Mar. 17, 2023

Related U.S. Application Data
(60) Provisional application No. 63/325,896, filed on Mar. 31, 2022.

(51) Int. Cl. E06B 9/326; E06B 9/262; E06B 9/302; E06B 9/322

(52) U.S. Cl. CPC E06B 9/326; E06B 9/262; E06B 9/302; E06B 9/322; E06B 2009/2627

(57) ABSTRACT

An actuating system for a window shade includes a control module actuatable for adjusting a shading structure of the window shade. The control module includes a wand having a hollow interior, a flexible operating element extending outside the wand at a first end thereof, a handle coupled to the operating element and disposed at a second end of the wand, the handle being operable to pull the operating element for actuating the control module, and an anti-winding guard of an elongate shape, the operating element, the handle and the anti-winding guard being movable in unison relative to the wand. The anti-winding guard is configured to extend outside the wand between the handle and the second end of the wand when the handle moves away from the second end of the wand.

### CROSS-REFERENCE TO RELATED APPLICATION(S)

This application claims priority to U.S. provisional patent application No. 63/325,896 filed on Mar. 31, 2022, the disclosure of which is hereby incorporated by reference.

### BACKGROUND

### 1. Field of the Invention

The present invention relates to window shades, and actuating systems used in window shades.

### 2. Description of the Related Art

Some window shades may use an operating cord for raising a bottom part of the window shade and a wand for lowering the bottom part. More specifically, the operating cord may be pulled to drive a rotary part in rotation, which can be transmitted to a drive axle so that the drive axle can rotate for winding a suspension cord connected with the bottom part. When a user rotates the wand, an arrester coupled to the wand can release the drive axle, which can accordingly rotate as the bottom part lowers under gravity action. Because a partial length of the operating cord becomes exposed when the operating cord is pulled for raising the bottom part, the aforementioned window shades may not satisfy safety requirements that prescribe no cord exposure to prevent injuries caused by accidental coiling of the cord around a child's neck.

### SUMMARY

The present application describes a window shade and an actuating system for use with the window shade that can address the foregoing issues.

According to an embodiment, the actuating system includes a control module adapted to couple to a transmission axle, the control module being actuatable to rotate the transmission axle for adjusting a shading structure of a window shade. The control module includes a wand having a hollow interior extending between a first end and a second end of the wand, a flexible operating element extending outside the wand at the first end thereof, a handle coupled to the operating element and disposed at the second end of the wand, the handle being operable to pull the operating element for actuating the control module, and an anti-winding guard of an elongate shape, wherein the operating element, the handle and the anti-winding guard are movable in unison relative to the wand, and the anti-winding guard is configured to extend outside the wand between the handle and the second end of the wand when the handle moves away from the second end of the wand.

Moreover, the present application provides a window shade that incorporates the actuating system.

### BRIEF DESCRIPTION OF THE DRAWINGS

FIG. 1 is a perspective view illustrating an embodiment of a window shade having an actuating system;

FIG. 2 is a perspective view illustrating the window shade having a bottom part lowered from a head rail;

FIGS. 3-5 are schematic views illustrating exemplary operation of a control module of the actuating system for expanding a shading structure of the window shade;

FIGS. 6 and 7 are schematic views illustrating exemplary operation of the control module for collapsing the shading structure of the window shade;

FIG. 8 is an exploded view illustrating further construction details of the control module;

FIG. 9 is a side view illustrating a handle of the control module in a first position adjacent to a wand of the control module;

FIG. 10 is a side view illustrating the handle in a second position displaced away from the wand;

FIG. 11 is a cross-sectional view illustrating an example of an anti-winding guard fixedly connected to the handle, wherein the anti-winding guard includes a tube fixedly connected to the handle, and a flexible operating element of the control module is threaded through the tube and is anchored to the handle;

FIG. 12 is a cross-sectional view illustrating an example of an anti-winding guard fixedly connected to the handle, wherein the anti-winding guard includes a tube fixedly connected to the handle, and the flexible operating element is threaded through the tube and is anchored to the anti-winding guard;

FIG. 13 is a cross-sectional view illustrating an example of an anti-winding guard fixedly connected to the handle, wherein the anti-winding guard includes a solid rod fixedly connected to the handle, and the flexible operating element is anchored to the anti-winding guard;

FIG. 14 is a cross-sectional view illustrating an example of an anti-winding guard including a tube disposed apart from the handle and attached to the flexible operating element, the handle being connected to the anti-winding guard via a flexible link;

FIG. 15 is a cross-sectional view illustrating an example of an anti-winding guard including a solid rod disposed apart from the handle and attached to the flexible operating element, the handle being connected to the anti-winding guard via a flexible link;

FIGS. 16-18 are schematic views illustrating various configurations of the anti-winding guard when the handle is displaced to a position corresponding to a maximal extension of the flexible operating element; and

FIG. 19 is a schematic view illustrating a variant construction in which the wand has no sleeve.

### DETAILED DESCRIPTION OF THE EMBODIMENTS

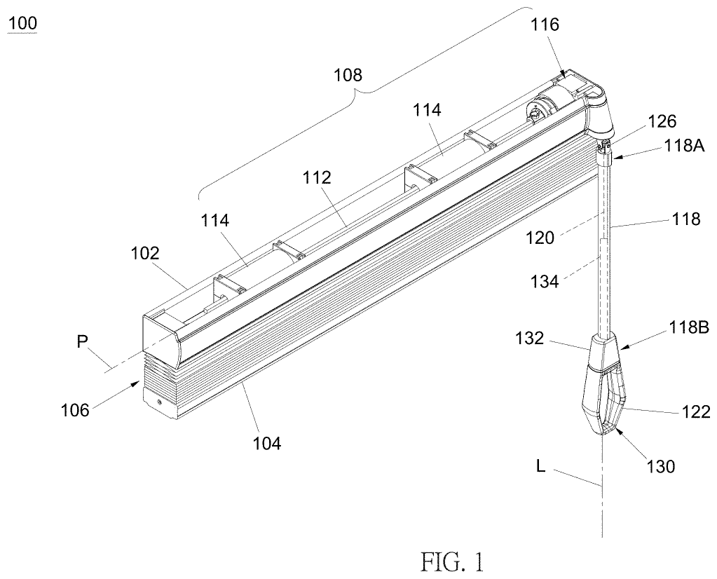

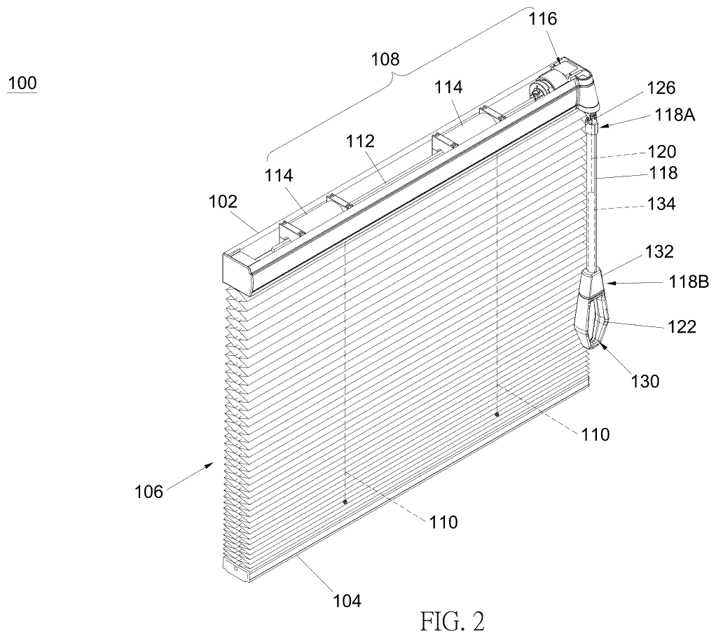

FIGS. 1 and 2 are two perspective views respectively illustrating an embodiment of a window shade 100 in different states. Referring to FIGS. 1 and 2, the window shade 100 can include a head rail 102, a bottom part 104, a shading structure 106 and an actuating system 108.

The head rail 102 may be affixed at a top of a window frame, and can have any desirable shapes. According to an example of construction, the head rail 102 can have an elongate shape including a cavity for at least partially receiving the actuating system 108 of the window shade 100.

The bottom part 104 can be suspended from the head rail 102 with a plurality of suspension elements 110 (shown with phantom lines in FIG. 2). According to an example of construction, the bottom part 104 may be an elongate rail having a channel adapted to receive to the attachment of the shading structure 106. Examples of the suspension elements 110 may include, without limitation, cords, strips, bands, and the like.

The shading structure 106 can also be suspended from the head rail 102. The shading structure 106 may exemplarily have a cellular structure, which may include, without limitation, honeycomb structures. However, it will be appreciated that the shading structure 106 may have any suitable structure that can be expanded and collapsed between the bottom part 104 and the head rail 102. The shading structure 106 can be disposed between the head rail 102 and the bottom part 104, and can have two opposite ends respectively attached to the head rail 102 and the bottom part 104.

Referring to FIGS. 1 and 2, the bottom part 104 is movable vertically relative to the head rail 102 for setting the window shade 100 to a desirable configuration. For example, the bottom part 104 may be raised toward the head rail 102 to collapse the shading structure 106 as shown in FIG. 1, or lowered away from the head rail 102 to expand the shading structure 106 as shown in FIG. 2. The vertical position of the bottom part 104 relative to the head rail 102 may be controlled with the actuating system 108.

Referring to FIGS. 1 and 2, the actuating system 108 is assembled with the head rail 102, and is operable to displace the bottom part 104 relative to the head rail 102 for adjustment. The actuating system 108 can include a transmission axle 112, a plurality of winding units 114 rotationally coupled to the transmission axle 112, and a control module 116 coupled to the transmission axle 112.

Referring to FIGS. 1 and 2, the transmission axle 112 is disposed inside the head rail 102. The transmission axle 112 is respectively coupled to the winding units 114, and can rotate about a pivot axis P. Each of the winding units 114 is respectively connected with the bottom part 104 via at least one suspension element 110, and is operable to wind the suspension element 110 for raising the bottom part 104 and to unwind the suspension element 110 for lowering the bottom part 104. For example, the winding unit 114 may include a rotary drum (not shown) that is rotationally coupled to the transmission axle 112 and is connected with one end of the suspension element 110, and another end of the suspension element 110 can be connected with the bottom part 104, whereby the rotary drum can rotate along with the transmission axle 112 to wind or unwind the suspension element 110. Since the winding units 114 are commonly coupled to the transmission axle 112, the winding units 114 can operate in a concurrent manner for winding and unwinding the suspension elements 110.

The control module 116 is assembled with the head rail 102. The control module 116 is adapted to couple to the transmission axle 112, and is actuatable to rotate the transmission axle 112 about the pivot axis P for adjusting the shading structure 106. More specifically, the control module 116 can include a wand 118, and a flexible operating element 120 (shown with phantom lines in FIGS. 1 and 2) and a handle 122 coupled to each other, the wand 118 and the handle 122 being operable independently of each other for adjusting the shading structure 106.

The wand 118 can have an elongate shape extending along a lengthwise axis L of the wand 118 between two opposite ends 118A and 118B thereof, and a hollow interior extending between the two ends 118A and 118B. Examples of materials for making the wand 118 may include, without limitation, plastic materials. The end 118A of the wand 118 can be pivotally connected to the head rail 102 via an articulation 126. The articulation 126 can be configured to allow rotation of the wand 118 about the lengthwise axis L and tilting of the wand 118 to different inclination relative to the head rail 102. The wand 118 is rotatable about the lengthwise axis L for actuating the control module 116.

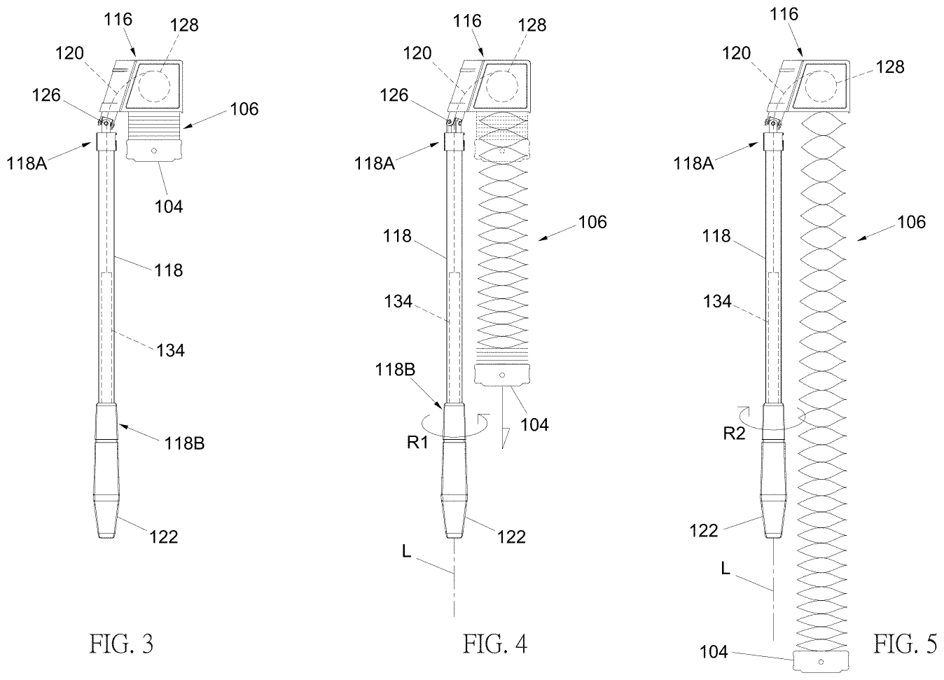

The operating element 120 can include any flexible linear components. Examples for making the operating element 120 can include, without limitation, cords, strips, cables and the like. The operating element 120 extends outside the wand 118 at the end 118A, and can have an end connected to a rotary drum 128 of the control module 116 (shown with phantom lines in FIGS. 3-7). The rotary drum 128 is rotatable for winding and unwinding the operating element 120. Moreover, the operating element 120 can be threaded through the articulation 126 and the end 118A of the wand 118, and can extend along the lengthwise axis L inside the hollow interior of the wand 118.

The handle 122 is disposed at the end 118B of the wand 118, and is coupled to the operating element 120. The handle 122 can have any suitable shapes that can be manually grasped by a user for operation. In the illustrated example, the handle 122 may have an opening 130 for facilitating manual holding of the handle 122 during operation. It will be appreciated, however, that the handle 122 is not limited to the illustrated example and may have other structures. The handle 122 is operable to actuate the control module 116 by pulling the operating element 120 so that the rotary drum 128 is urged in rotation in the unwind direction. More specifically, the handle 122 is movable relative to the wand 118 between a first position where the handle 122 is located adjacent to the end 118B of the wand 118, and a second position where the handle 122 is displaced away from the end 118B of the wand 118. The handle 122 can be pulled away from the end 118B of the wand 118 to urge the rotary drum 128 to rotate, whereby the control module 116 is actuated for adjusting the shading structure 106.

Referring to FIGS. 1 and 2, the wand 118 can have a sleeve 132 fixedly connected thereto at the end 118B, the sleeve 132 having a cross-section that is larger than a cross-section of the wand 118. The handle 122 can lie adjacent to and can be at least partially received in the sleeve 132 in the first position. The sleeve 132 can facilitate positioning of the handle 122 in the first position.

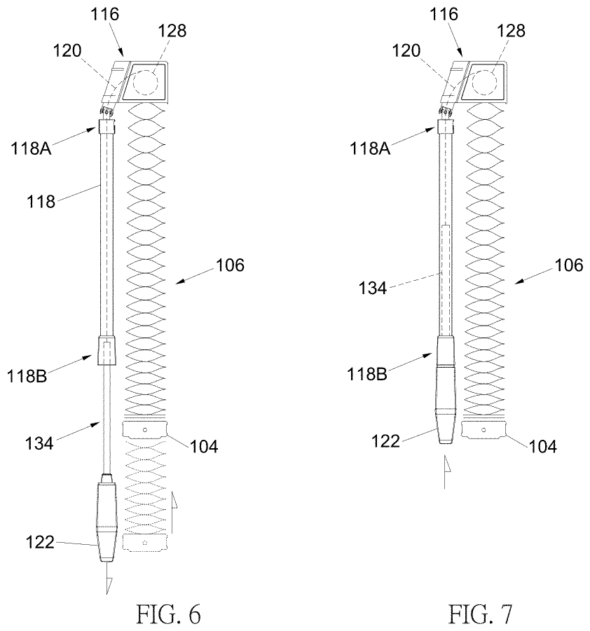

In conjunction with FIGS. 1 and 2, FIGS. 3-5 are schematic views illustrating exemplary operation of the control module 116 for expanding the shading structure 106, and FIGS. 6 and 7 are schematic views illustrating exemplary operation of the control module 116 for collapsing the shading structure 106. The control module 116 can be configured so that the handle 122 is operable to pull the operating element 120 for displacing vertically the shading structure 106. More specifically, the control module 116 can be configured so that the handle 122 is operable to pull the operating element 120 for collapsing the shading structure 106, and the wand 118 is rotatable about the lengthwise axis L thereof for expanding the shading structure 106.

Referring to FIGS. 3-5, the bottom part 104 can be lowered for expanding the shading structure 106 by rotating the wand 118 about the lengthwise axis L in a first direction RE This angular displacement of the wand 118 can be made while the handle 122 remains in the first position adjacent to the end 118B of the wand 118. Once the bottom part 104 reaches a desirable lowered position, the wand 118 can be rotated about the lengthwise axis L in a second direction R2 opposite to the first direction R1 to recover its initial position, which stops the bottom part 104 at the desirable position.

Referring to FIGS. 6 and 7, the bottom part 104 can be raised a distance by displacing the handle 122 away from the end 118B of the wand 118, which pulls the operating element 120 and causes the rotary drum 128 to rotate in a direction that unwinds at least partially the operating element 120. While the bottom part 104 moves upward, the user can release the handle 122 at any time, e.g., when the bottom part 104 has reached a desired height or the operating element 120 has been entirely unwound from the rotary drum 128. When the handle 122 is released, the rotary drum 128 can rotate in a reverse direction that winds at least partially the operating element 120, which causes the handle 122 to move to its first position adjacent to the end 118B of the wand 118. While the handle 122 moves toward the end 118B of the wand 118, the bottom part 104 remains in position relative to the head rail 102. The aforementioned sequence of pulling and releasing the handle 122 can be repeated multiple times until the shading structure 106 is totally collapsed.

The control module 116 can have any suitable constructions for implementing the aforementioned operations. For example, the control module 116 may include one or more clutching elements (not shown) coupled to the rotary drum 128, and one or more braking springs (not shown) coupled to the wand 118. A rotation of the rotary drum 128 in the direction unwinding the operating element 120 can cause the one or more clutching elements to couple the rotary drum 128 to the transmission axle 112 so that the transmission axle 112 rotates along with the rotary drum 128 for raising the bottom part 104, and a rotation of the rotary drum 128 in the direction winding the operating element 120 can cause the one or more clutching elements to decouple the rotary drum 128 from the transmission axle 112 so that the transmission axle 112 is locked by the one or more braking springs for holding the bottom part 104 in position. An angular displacement of the wand 118 as shown in FIG. 4 can urge the one or more braking springs to release the transmission axle 112, which then can rotate for lowering the bottom part 104 by gravity action. Various constructions of control modules are known in the prior art to include the aforementioned clutching elements and braking springs, which are not illustrated herein for the sake of clarity.

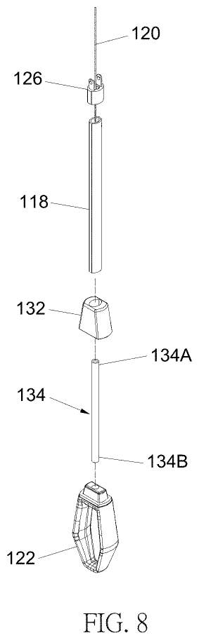

In conjunction with FIG. 6, FIG. 8 is an exploded view illustrating further construction details of the control module 116. Referring to FIGS. 6 and 8, the control module 116 further includes an anti-winding guard 134. The anti-winding guard 134 has an elongate shape extending between two opposite ends 134A and 134B of the anti-winding guard 134, and has a stiffness that can prevent coiling of the anti-winding guard 134. Examples of suitable materials for making the anti-winding guard 134 may include, without limitation, plastic materials, metallic materials, and the like. In some examples of construction, the stiffness of the anti-winding guard 134 may be such that the anti-winding guard 134 may be subjected to some degree of bending without forming a loop, which can provide an anti-winding function. The anti-winding guard 134 is coupled to the operating element 120 and the handle 122, and is configured to extend outside the wand 118 between the handle 122 and the end 118B of the wand 118 when the handle 122 moves away from the end 118B of the wand 118. More specifically, the anti-winding guard 134 is dimensioned to be positionable inside the hollow interior of the wand 118 through the end 118B thereof, and is coupled to the operating element 120 and the handle 122 so that the operating element 120, the handle 122 and the anti-winding guard 134 are movable in unison relative to the wand 118. During operation, the anti-winding guard 134 is thus movable through the end 118B into and out of the wand 118.

In conjunction with FIGS. 1-8, FIG. 9 is a side view illustrating the handle 122 in a first position adjacent to the end 118B of the wand 118, and FIG. 10 is a side view illustrating the handle 122 in a second position displaced away from the end 118B of the wand 118. The second position of the handle 122 in FIG. 10 may illustrate, for example, a maximal displacement of the handle 122 away from the end 118B of the wand 118, which can correspond to a maximal extension of the operating element 120 from the rotary drum 128. The anti-winding guard 134 is dimensioned so that the anti-winding guard 134 can be exposed and occupy a substantial portion of a distance between the end 118B of the wand 118 and the handle 122 when the handle 122 is in the second position corresponding to a maximal extension of the operating element 120 from the rotary drum 128. According to an example of construction, while the handle 122 is in the second position, the anti-winding guard 134 can occupy at least half of the distance between the end 118B of the wand 118 and the handle 122. According to an example of construction, while the handle 122 is in the second position, the anti-winding guard 134 can occupy at least two-thirds of the distance between the end 118B of the wand 118 and the handle 122. According to an example of construction, while the handle 122 is in the second position, the anti-winding guard 134 can occupy at least three-quarters of the distance between the end 118B of the wand 118 and the handle 122. According to an example of construction, while the handle 122 is in the second position, the anti-winding guard 134 can occupy the entire distance between the end 118B of the wand 118 and the handle 122. Accordingly, the anti-winding guard 134 is configurable to be substantially or entirely exposed outside the wand 118 when the handle 122 is in the second position.

When the control module 116 is actuated by displacing the handle 122 away from the end 118B of the wand 118, the extension of the anti-winding guard 134 outside the wand 118 can prevent substantial exposure of the operating element 120 between the end 118B of the wand 118 and the handle 122. As a result, injuries caused by accidental coiling of the operating element 120 around a child's neck can be prevented. Owing to its anti-winding characteristic, the exposed anti-winding guard 134 cannot coil around a child's neck and thus would not pose a risk of harm.

When the handle 122 is in the first position adjacent to the end 118B of the wand 118, the anti-winding guard 134 can be substantially or entirely received inside the hollow interior of the wand 118. A compact arrangement thus can be obtained. While the anti-winding guard 134 is retracted inside the wand 118, the wand 118 is rotatable about the lengthwise axis L for lowering the bottom part 104.

The operating element 120, the handle 122 and the anti-winding guard 134 may be coupled to one another through various constructions. For example, the anti-winding guard 134 can be fixedly connected to the handle 122, or can be disposed apart from the handle 122 and attached to the operating element 120.

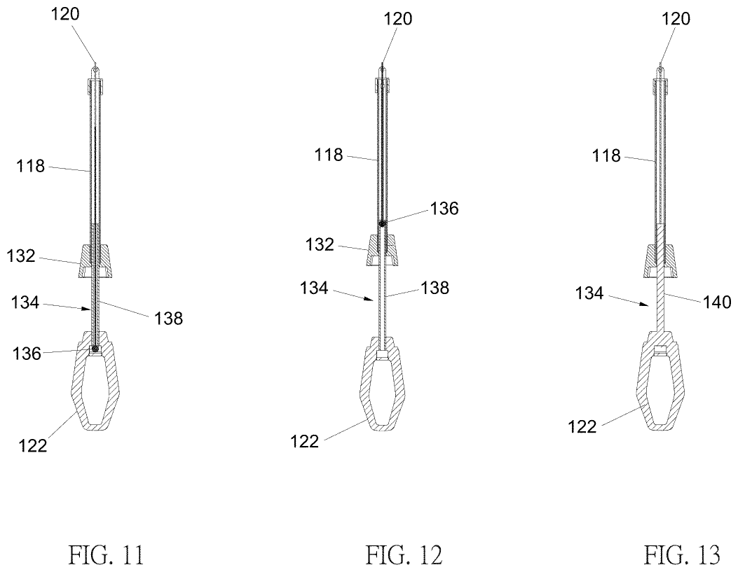

In conjunction with FIGS. 8-10, FIGS. 11-13 are cross-sectional views illustrating some examples in which the anti-winding guard 134 is fixedly connected to the handle 122. Referring to FIGS. 11-13, the anti-winding guard 134 can be fixedly connected to the handle 122, and the operating element 120 can have an end 136 anchored to the handle 122 or the anti-winding guard 134.

In the example of FIG. 11, the anti-winding guard 134 includes a tube 138 that is fixedly connected to the handle 122, the operating element 120 is threaded through a hollow interior of the tube 138, and the end 136 of the operating element 120 is anchored to the handle 122. The tube 138 may be provided as a separate part fastened to the handle 122 at one end, or may be formed integrally with the handle 122. The end 136 of the operating element 120 can be fixedly connected to the handle 122 through any suitable techniques. For example, the end 136 of the operating element 120 can be engaged with a retaining structure provided in the handle 122.

In the example of FIG. 12, the tube 138 is likewise fixedly connected to the handle 122 at one end, and the end 136 of the operating element 120 is anchored to the tube 138. For example, the end 136 of the operating element 120 can be engaged with a retaining structure provided at an end of the tube 138 opposite to the handle 122.

In the example of FIG. 13, the anti-winding guard 134 includes a solid rod 140 having no hollow interior. The rod 140 is fixedly connected to the handle 122, and the operating element 120 is anchored to the rod 140. The rod 140 may be provided as a separate part fastened to the handle 122 at one end, or may be formed integrally with the handle 122. Suitable techniques for anchoring the operating element 120 to the handle 122 may include, without limitation, bonding, tying, or fastening an end of the operating element 120 to the rod 140.

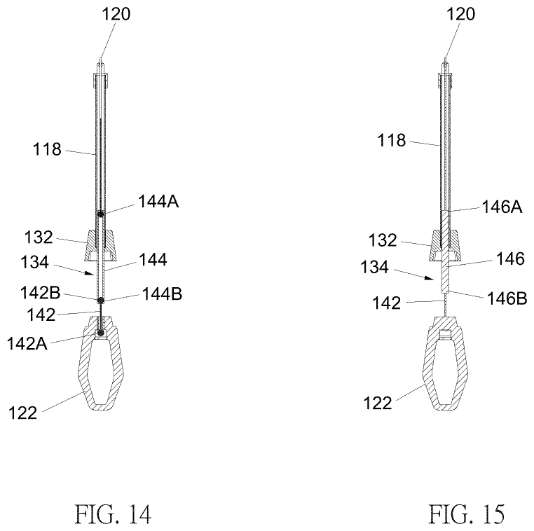

FIGS. 14 and 15 are cross-sectional views illustrating some examples in which the anti-winding guard 134 is disposed apart from the handle 122 and attached to the operating element 120, and the handle 122 is connected to the anti-winding guard 134 via a flexible link 142.

In the example of FIG. 14, the anti-winding guard 134 includes a tube 144 having two opposite ends 144A and 144B. The flexible link 142 may include, without limitation, a cord, a cable, a strip, and the like. The operating element 120 can be anchored to the anti-winding guard 134, and the flexible link 142 can be anchored to the handle 122 and the anti-winding guard 134. For example, the operating element 120 can be anchored to the end 144A of the tube 144, and the flexible link 142 can have two opposite ends 142A and 142B respectively anchored to the handle 122 and the end 144B of the tube 144.

In the example of FIG. 15, the anti-winding guard 134 includes a solid rod 146 having two opposite ends 146A and 146B. The operating element 120 can be anchored to the end 146A of the rod 146, and the flexible link 142 can be respectively anchored to the handle 122 and the end 146B of the rod 146.

In conjunction with FIGS. 6 and 10-15, FIGS. 16-18 are schematic views illustrating various configurations of the anti-winding guard 134 when the handle 122 is displaced to the second position corresponding to a maximal extension of the operating element 120 from the rotary drum 128.

Referring to FIG. 10, the anti-winding guard 134 is fixedly connected to the handle 122, and can occupy the entire distance between the end 118B of the wand 118 and the handle 122.

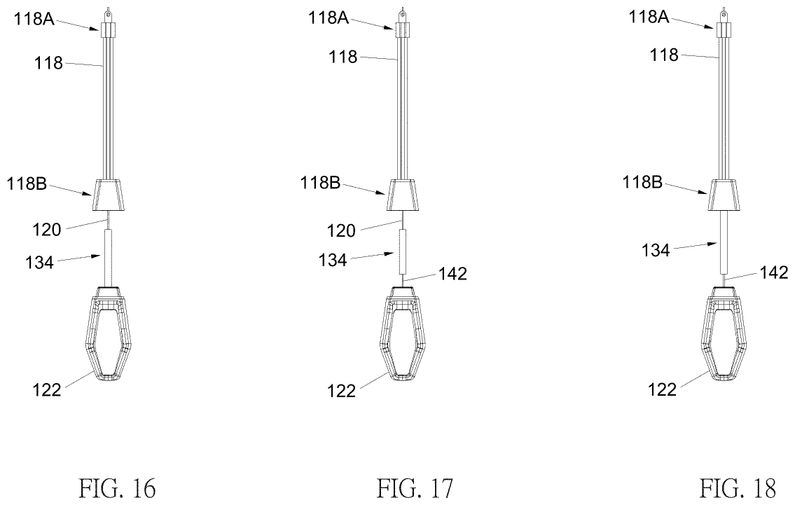

Referring to FIG. 16, the anti-winding guard 134 is fixedly connected to the handle 122, and occupies a substantial portion of the distance between the end 118B of the wand 118 and the handle 122. The operating element 120 may be slightly exposed between the end 118B of the wand 118 and the anti-winding guard 134.

Referring to FIG. 17, the anti-winding guard 134 is disposed apart from the handle 122 and attached to the operating element 120. The operating element 120 is slightly exposed between the end 118B of the wand 118 and the anti-winding guard 134, and the flexible link 142 is exposed between the handle 122 and the anti-winding guard 134.

Referring to FIG. 18, the anti-winding guard 134 is disposed apart from the handle 122 and attached to the operating element 120. The anti-winding guard 134 has a portion remaining inside the wand 118, and the flexible link 142 is exposed between the handle 122 and the anti-winding guard 134.

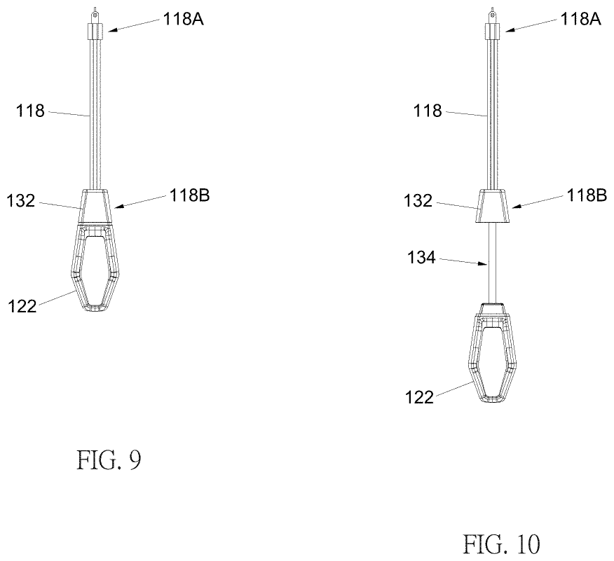

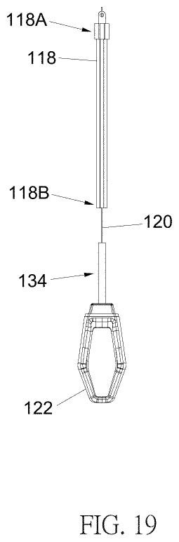

FIG. 19 is a schematic view illustrating a variant construction in which the wand 118 has no sleeve 132 (shown in FIGS. 9 and 10) at the end 118B. The anti-winding guard 134 is fixedly connected to the handle 122, and is movable to retract into and extend outside the wand 118 as the handle 122 moves toward and away from the end 118B of the wand 118.

Advantages of the structures described herein include the ability to provide a window shade that has an actuating system operable to lower and raise a bottom part of the window shade in a convenient manner, and can effectively prevent injuries caused by accidental coiling of a flexible operating element around a child's neck.

Realizations of the structures have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. An actuating system for a window shade, comprising:
a control module adapted to couple to a transmission axle, the control module being actuatable to rotate the transmission axle for adjusting a shading structure of a window shade, wherein the control module includes:
a wand having a hollow interior extending between a first end and a second end of the wand;
a flexible operating element extending outside the wand at the first end thereof, and a handle coupled to the operating element and disposed at the second end of the wand, the handle being operable to pull the operating element for actuating the control module; and
an anti-winding guard of an elongate shape, wherein the operating element, the handle and the anti-winding guard are movable in unison relative to the wand, and the anti-winding guard is configured to extend outside the wand between the handle and the second end of the wand when the handle moves away from the second end of the wand.

2. The actuating system according to claim 1, wherein the anti-winding guard is dimensioned to be positionable inside the hollow interior of the wand.

3. The actuating system according to claim 1, wherein the anti-winding guard is movable through the second end into and out of the wand.

4. The actuating system according to claim 1, wherein the handle is movable between a first position adjacent to the second end of the wand and a second position away from the second end of the wand, the anti-winding guard being exposed and occupying a substantial portion of a distance between the second end of the wand and the handle when the handle is in the second position.

5. The actuating system according to claim 4, wherein the anti-winding guard is substantially or entirely exposed outside the wand when the handle is in the second position.

6. The actuating system according to claim 4, wherein the anti-winding guard occupies at least half of the distance between the second end of the wand and the handle when the handle is in the second position.

7. The actuating system according to claim 4, wherein the anti-winding guard occupies at least two-thirds of the distance between the second end of the wand and the handle when the handle is in the second position.

8. The actuating system according to claim 4, wherein the anti-winding guard is substantially or entirely received inside the hollow interior of the wand when the handle is in the first position.

9. The actuating system according to claim 4, wherein the wand is fixedly connected to a sleeve at the second end, the sleeve having a cross-section that is larger than a cross-section of the wand, the handle lying adjacent to the sleeve in the first position.

10. The actuating system according to claim 4, wherein the second position corresponds to a maximal displacement of the handle away from the second end of the wand.

11. The actuating system according to claim 1, wherein the anti-winding guard is fixedly connected to the handle, or is disposed apart from the handle and attached to the operating element.

12. The actuating system according to claim 11, wherein the anti-winding guard is fixedly connected to the handle, and the operating element has an end anchored to the anti-winding guard or the handle.

13. The actuating system according to claim 11, wherein the anti-winding guard is disposed apart from the handle and attached to the operating element, and the handle is connected to the anti-winding guard via a flexible link.

14. The actuating system according to claim 1, wherein the anti-winding guard includes a tube having a hollow interior, or a solid rod having no hollow interior.

15. The actuating system according to claim 1, wherein the anti-winding guard includes a tube, and the operating element is threaded through a hollow interior of the tube.

16. The actuating system according to claim 15, wherein the tube is fixedly connected to the handle, and an end of the operating element is anchored to the handle.

17. The actuating system according to claim 1, wherein substantial exposure of the operating element between the second end of the wand and the handle is prevented when the handle moves away from the second end of the wand.

18. The actuating system according to claim 1, wherein the handle is operable to pull the operating element for displacing vertically a shading structure of a window shade.

19. The actuating system according to claim 18, wherein the handle is operable to pull the operating element for collapsing a shading structure of a window shade, and the wand is rotatable about a lengthwise axis thereof for expanding the shading structure of the window shade.

20. A window shade comprising:
a head rail having a transmission axle;
a shading structure and a bottom part suspended from the head rail; and
the actuating system according to claim 1, wherein the control module is assembled with the head rail, the wand being pivotally connected to the head rail.
